(19) United States
(12) Patent Application Publication
(10) Pub. No.: US 2007/0270195 A1
(43) Pub. Date: Nov. 22, 2007

(54) ROAMING FUNCTION TEST SYSTEM AND METHOD

(75) Inventor: YING-MING LIANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/608,812

(22) Filed: Dec. 9, 2006

(30) Foreign Application Priority Data
May 19, 2006 (TW) 95117954

(51) Int. Cl. H04M 1/00

(52) U.S. Cl. 455/575.1

(57) ABSTRACT

A roaming function test system (10) for testing a roaming function of a mobile communication device (80) includes a first programmable attenuator (30), a second programmable attenuator (40), a first access point (AP) (50) connected to the first programmable attenuator, a second AP (60) connected to the second programmable attenuator, and a roaming function test apparatus (20) connected to the first programmable attenuator, the second programmable attenuator, the first AP, and the second AP. The first AP and the second AP are both for communicating with the mobile communication device. The roaming function test apparatus controls attenuation of the first programmable attenuator to decrease and attenuation of the second programmable attenuator to increase, and determines whether the roaming function of the mobile communication device is normal.

### BACKGROUND OF THE INVENTION

1. Field of the Invention

The invention relates to test systems and methods, and particularly to a system and method for testing roaming functions of mobile communication devices.

2. Description of Related Art

Mobile phones become more and more popular due to convenient mobility. Most users often need to move from place to place. Thus, it is very important to ensure that roaming functions of the mobile phones are normal.

Conventional methods for testing roaming functions of mobile phones need a tester to move a mobile phone under test manually, to implement roaming of the mobile phone. However, the above method wastes a lot of time, and is inefficient.

### SUMMARY OF THE INVENTION

An embodiment of the invention provides a roaming function test system for testing a roaming function of a mobile communication device. The roaming function test system includes a first programmable attenuator, a second programmable attenuator, a first access point (AP) connected to the first programmable attenuator, a second AP connected to the second programmable attenuator, and a roaming function test apparatus connected to the first programmable attenuator, the second programmable attenuator, the first AP, and the second AP. The first AP and the second AP are both for communicating with the mobile communication device. The roaming function test apparatus controls attenuation of the first programmable attenuator to decrease and attenuation of the second programmable attenuator to increase, and determines whether the roaming function of the mobile communication device is normal.

Another embodiment of the invention provides a roaming function test method for testing a roaming function of a mobile communication device. The roaming function test method includes: configuring test data; controlling attenuation of a first programmable attenuator to decrease and attenuation of a second programmable attenuator to increase according to the test data; detecting whether a roaming function test apparatus can communicate with a first AP or a second AP within a predetermined period to determine whether the roaming function of the mobile communication device is normal; and generating a test report.

Other advantages and novel features will become more apparent from the following detailed description when taken in conjunction with the accompanying drawings.

### BRIEF DESCRIPTION OF THE DRAWINGS

FIG. 1 is a schematic diagram of a roaming function test system of an exemplary embodiment of the invention.

FIG. 2 is a schematic diagram of a roaming function test apparatus of another exemplary embodiment of the invention.

FIG. 3 is a flowchart of a roaming function test method of a further exemplary embodiment of the invention.

FIG. 4 is a flowchart of a roaming function test method of another further exemplary embodiment of the invention.

### DETAILED DESCRIPTION OF THE INVENTION

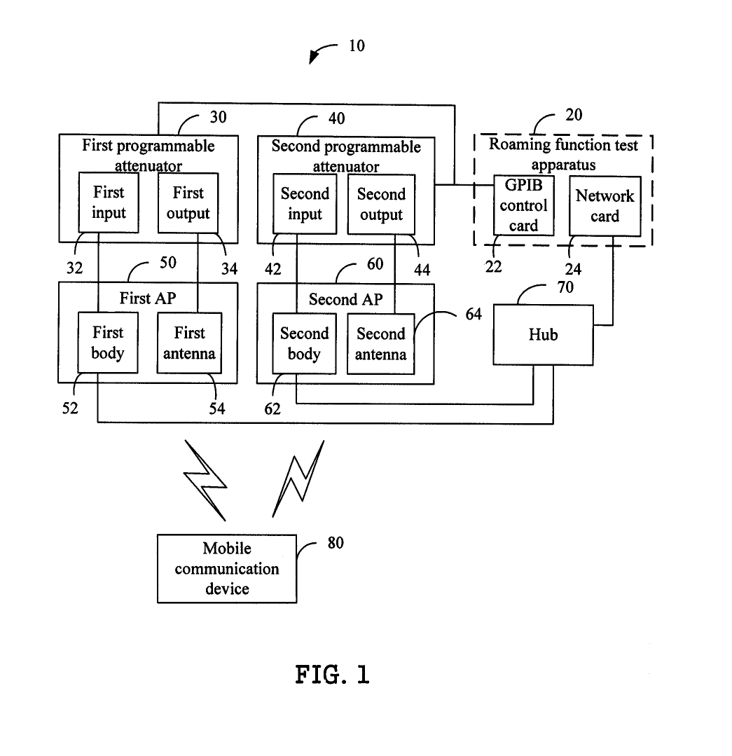

FIG. 1 is a schematic diagram of a roaming function test system 10 of an exemplary embodiment of the invention. In the exemplary embodiment, the roaming function test system 10 is used for testing a roaming function of a mobile communication device 80, and includes a roaming function test apparatus 20, a first programmable attenuator 30, a second programmable attenuator 40, a first access point (AP) 50, and a second AP 60. In alternative embodiments of the invention, the roaming function test system 10 may test a plurality of mobile communication devices 80.

The first programmable attenuator 30 has a first input 32 and a first output 34, and the second programmable attenuator 40 has a second input 42 and a second output 44. The first AP 50 is connected to the first programmable attenuator 30, and the second AP 60 is connected to the second programmable attenuator 40. The first AP 50 and the second AP 60 are both used for communicating with the mobile communication device 80. In the exemplary embodiment, the first AP 50 includes a first body 52 and a first antenna 54, and the second AP 60 includes a second body 62 and a second antenna 64. The first body 52 is connected to the first input 32 of the first programmable attenuator 30, and the first antenna 54 is connected to the first output 34. The second body 62 is connected to the second input 42, and the second antenna 64 is connected to the second output 44. The mobile communication device 80 is in a co-coverage area of the first AP 50 and the second AP 60.

The roaming function test apparatus 20 is connected to the first programmable attenuator 30, the second programmable attenuator 40, the first AP 50, and the second AP 60, and is used for controlling attenuation of the first programmable attenuator 30 to decrease and attenuation of the second programmable attenuator 40 to increase, i.e., adjusting signal strength of the first AP 50 and inversely adjusting signal strength of the second AP 60, and determining whether the roaming function of the mobile communication device 80 is normal. In the exemplary embodiment, the roaming function test apparatus 20 may be a computer, and includes a general purpose interface bus (GPIB) control card 22 and a network card 24. The first programmable attenuator 30 and the second programmable attenuator 40 are respectively connected to the GPIB control card 22 via GPIB cables.

The roaming function test system 10 further includes a hub 70. The hub 70 is connected to the roaming function test apparatus 20 via the network card 24, and is connected to the first AP 50 and the second AP 60 via network cables.

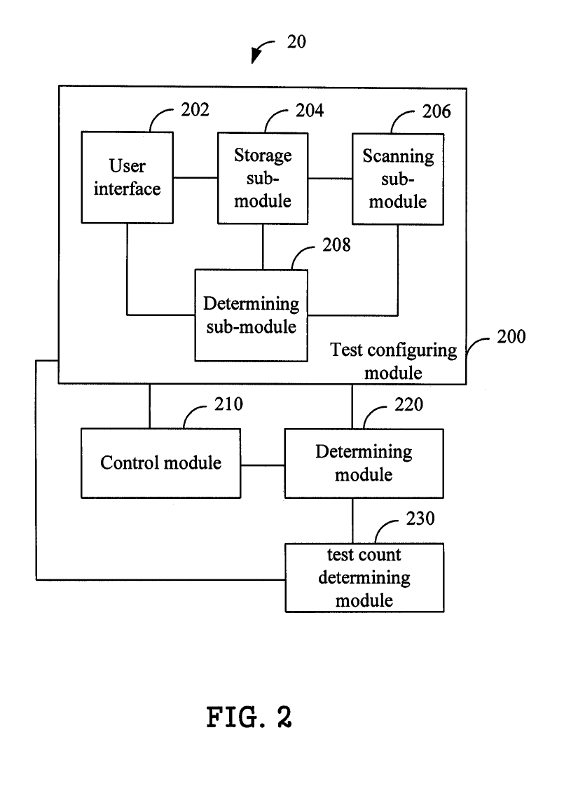

FIG. 2 is a schematic diagram of the roaming function test apparatus 20 of an exemplary embodiment of the invention. In the exemplary embodiment, the roaming function test apparatus 20 includes a test configuring module 200, a control module 210, and a determining module 220. The testing configuring module 200 is used for configuring test data. In the exemplary embodiment, the test data includes configuration data, scenario data, and test item data. The configuration data includes an Internet protocol (IP) address of the roaming function test apparatus 20, GPIB addresses of the first programmable attenuator 30 and the second programmable attenuator 40, and IP addresses of the first AP 50 and the second AP 60. The test item data includes a predetermined test count, a roaming time, original values and terminal values of attenuation of the first programmable attenuator 30 and the second programmable attenuator 40. The scenario data is used for representing selected mobile communication devices 80 that need to be tested. In the exemplary embodiment, the roaming time may be 30 seconds.

The test configuring module 200 includes a user interface 202, a storage sub-module 204, a scanning sub-module 206, and a determining sub-module 208. The user interface 202 is used for receiving test data input by an operator and saving the input test data in the storage sub-module 204. In the exemplary embodiment, the user interface 202 may be a graphical user interface, which can display the input test data to the operator. The scanning sub-module 206 is connected to the user interface 202 and the storage sub-module 204, and is used for scanning configuration data of the test data saved in the storage sub-module 204 to determine whether the configuration data is correct. That is, the scanning sub-module 206 scans connections among the first programmable attenuator 30, the second programmable attenuator 40, the first AP 50, the second AP 60, and the roaming function test apparatus 20, to determine whether a connection of the roaming function test system 10 is normal. The determining sub-module 208 is connected to the user interface 202, the storage sub-module 204, and the scanning sub-module 206, and is used for determining whether test data configuration is finished so testing can begin.

The control module 210 is connected to the test configuring module 200, and is used for controlling attenuation of the first programmable attenuator 30 to decrease and attenuation of the second programmable attenuator 40 to increase according to test item data of the test data, i.e., adjusting signal strength of the first AP 50 and inversely adjusting signal strength of the second AP 60. Thus, roaming of the mobile communication device 80 from the first AP 50 connected to the first programmable attenuator 30 to the second AP 60 connected to the second programmable attenuator 40 is simulated. In the exemplary embodiment, the control module 210 controls attenuation of the first programmable attenuator 30 to decrease and attenuation of the second programmable attenuator 40 to increase according to the roaming time and the original values and terminal values of attenuation of the first programmable attenuator 30 and the second programmable attenuator 40 of the test item data. In alternative embodiments, the control module 210 may control attenuation of the first programmable attenuator 30 to increase and attenuation of the second programmable attenuator 40 to decrease.

The determining module 220 is connected to the test configuring module 200 and the control module 210, and is used for determining whether the roaming function of the mobile communication device 80 is normal and generating a test report. In the exemplary embodiment, the determining module 220 detects whether the roaming function test apparatus 20 can communicate with the first AP 50 or the second AP 60 within a predetermined period, to determine whether the roaming function of the mobile communication device 80 is normal. If the roaming function test apparatus 20 can communicate with the first AP 50 or the second AP 60 within the predetermined period, the determining module 220 retrieves a media access control (MAC) address of the mobile communication device 80 from a corresponding AP communicating with the mobile communication device 80. The test report includes a test count of the roaming function test system 10, the original values and terminal values of attenuation of the first programmable attenuator 30 and the second programmable attenuator 40, the roaming time, and test results of each test. The test results include whether the roaming function is normal or abnormal. The determining module 220 further determines whether the roaming time has elapsed.

The user interface 202 further displays the test report and the retrieved MAC address of the mobile communication device 80.

The roaming function test apparatus 20 further includes a test count determining module 230. The test count determining module 230 is connected to the determining module 220 and the test configuring module 200, and is used for determining whether the test count of the roaming function test system 10 is equal to the predetermined test count of the test item data.

When the test configuring module 200 finishes the test data configuration, testing begins and the control module 210 of the roaming function test apparatus 20 controls attenuation of the first programmable attenuator 30 to decrease from 100 dB to 0 dB, and attenuation of the second programmable attenuator 40 to increase from 0 dB to 100 dB via the GPIB cables. At the beginning of the roaming time, that is, a moment that attenuation of the first programmable attenuator 30 begins to decrease, and attenuation of the second programmable attenuator 40 begins to increase, the determining module 220 begins to determine whether the roaming function of the mobile communication device 80 is normal. When the roaming time has elapsed, the determining module 220 generates the test report, and the user interface 202 displays the test report. Then the test count determining module 230 determines whether the test count of the roaming function test system 10 is equal to the predetermined test count.

During the roaming time, the determining module 220 continuously pings the first AP 50 and the second AP 60. If the determining module 220 receives a response from the first AP 50 or the second AP 60 within the predetermined period, the determining module 220 retrieves the MAC address of the mobile communication device 80 from a corresponding AP communicating with the mobile communication device 80. That is, the roaming function of the mobile communication device 80 is normal. If the determining module 220 does not receive a response from the first AP 50 and the second AP 60 within the predetermined period, the roaming function of the mobile communication device 80 is abnormal. In the exemplary embodiment, the predetermined period may be 3 seconds. During the roaming time, the determining module 220 can only communicate with one of the first AP 50 and the second AP 60. For example, if the roaming function of the mobile communication device 80 is normal, during the time that the first programmable attenuator 30 decreases from 100 dB to 50 dB and the second programmable attenuator 40 increases from 0 dB to 50 dB, the mobile communication device 80 is in a coverage area of the first AP 50, and can only communicate with the first AP 50, and the determining module 220 only receives responses from the first AP 50; during the time that the first programmable attenuator 30 decreases from 50 dB to 0 dB and the second programmable attenuator 40 increases from 50 dB to 100 dB, the mobile communication device 80 is in a coverage area of the second AP 60, that is, the roaming of the mobile communication device 80 is simulated, and the determining module 220 only receives responses from the second AP 60. Thus, roaming of the mobile communication device 80 from a coverage area of the first AP 50 to a coverage area of the second AP 60 is simulated.

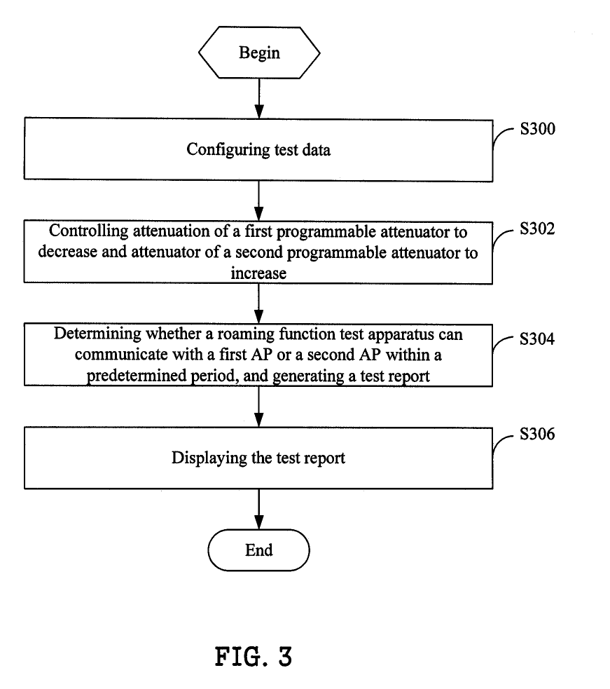

FIG. 3 is a flowchart of a roaming function test method of an exemplary embodiment of the invention. In step S300, the test configuring module 200 configures test data. In step S302, the control module 210 controls attenuation of the first programmable attenuator 30 to decrease and attenuation of the second programmable attenuator 40 to increase according to the test data. Although the mobile communication device 80 does not move, roaming of the mobile communication device 80 from the first AP 50 to the second AP 60 is simulated.

In step S304, the determining module 220 detects whether the roaming function test apparatus 20 can communicate with the first AP 50 or the second AP 60 within the predetermined period to determine whether the roaming function of the mobile communication device 80 is normal, and generates a test report. In step S306, the user interface 202 displays the test report.

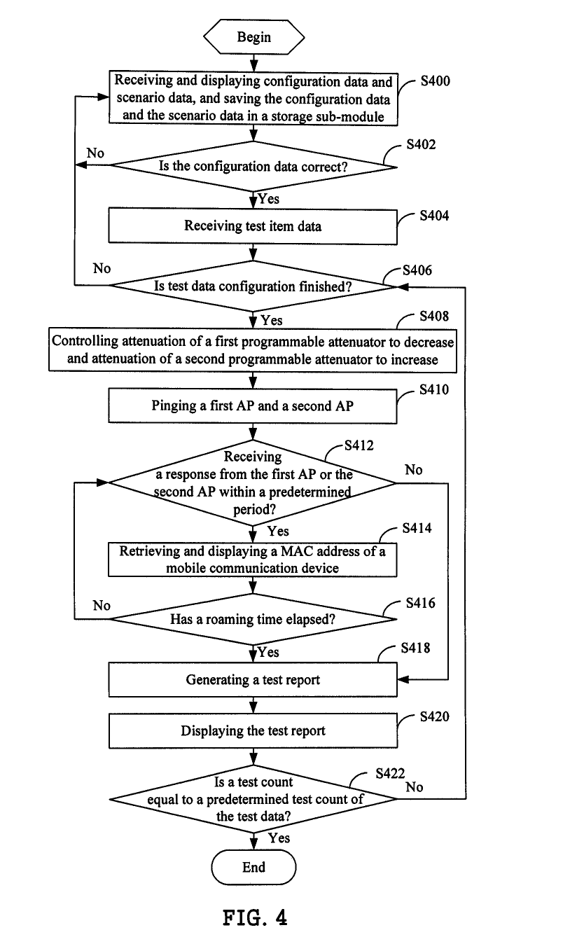

FIG. 4 is a flowchart of a roaming function test method of another exemplary embodiment of the invention. In step S400, the user interface 202 receives and displays configuration data and scenario data input by the operator, and saves the configuration data and the scenario data in the storage sub-module 204. In the exemplary embodiment, the configuration data includes the IP address of the roaming function test apparatus 20, the GPIB addresses of the first programmable attenuator 30 and the second programmable attenuator 40, and the IP addresses of the first AP 50 and the second AP 60.

In step S402, the scanning sub-module 206 scans the configuration data in the storage sub-module 204 to determine whether the configuration data is correct. That is, the scanning sub-module 206 scans connections among the first programmable attenuator 30, the second programmable attenuator 40, the first AP 50, the second AP 60, and the roaming function test apparatus 20, to determine whether a connection of the roaming function test system 10 is normal. If the configuration data is incorrect, the process returns to step S400 to let the operator input new configuration data.

If the configuration data is correct, in step S404, the user interface 202 receives test item data input by the operator. In the exemplary embodiment, the test item data includes a predetermined test count, a roaming time, original values and terminal values of attenuation of the first programmable attenuator 30 and the second programmable attenuator 40.

In step S406, the determining sub-module 208 determines whether test data configuration is finished. If not finished, the process returns to step S400.

If the test data configuration is finished, testing begins, and in step S408, the control module 210 controls attenuation of the first programmable attenuator 30 to decrease and attenuation of the second programmable attenuator 40 to increase according to the test item data. In the exemplary embodiment, the control module 210 controls attenuation of the first programmable attenuator 30 to decrease from 100 dB to 0 dB and attenuation of the second programmable attenuator 40 to increase from 0 dB to 100 dB during the roaming time.

In step S410, the determining module 220 continuously pings the first AP 50 and the second AP 60 during the roaming time.

In step S412, the determining module 220 determines whether a response is received from the first AP 50 or the second AP 60 within a predetermined period to determine whether the roaming function of the mobile communication device 80 is normal.

If the determining module 220 receives a response from the first AP 50 or the second AP 60 within the predetermined period, the roaming function of the mobile communication device 80 is normal. If the determining module 220 does not receive a response from the first AP 50 and the second AP 60, the roaming function of the mobile communication device 80 is abnormal.

If the determining module 220 receives a response from the first AP 50 or the second AP 60 within the predetermined period, in step S414, the determining module 230 retrieves the MAC address of the mobile communication device 80 from a corresponding AP communicating with the mobile communication device 80, and displays the retrieved MAC address on the user interface 202.

In step S416, the determining module 230 determines whether the roaming time has elapsed. If the roaming time has not elapsed, the process returns to step S412.

If the roaming time has elapsed, in step S418, the determining module 220 generates a test report. In the exemplary embodiment, the test report includes a test count of the roaming function test system 10, the original values and terminal values of attenuation of the first programmable attenuator 30 and the second programmable attenuator 40, the roaming time, and test results of each test. The test results include whether the roaming function is normal or abnormal.

In step S420, the user interface 202 displays the test report.

If the determining module 220 does not receive a response from the first AP 50 and the second AP 60, the process goes directly to step S418, that is, the determining module 220 generates the test report.

In step S422, the test count determining module 230 determines whether the test count of the roaming function test system 10 is equal to the predetermined test count of the test data. If yes, the process ends. If not, the process returns to step S406 to begin a new test.

The roaming function test system 10 improves efficiency of testing roaming function of a communication device, and saves time and manpower.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A roaming function test system, for testing a roaming function of a mobile communication device, comprising:
a first programmable attenuator;
a second programmable attenuator;
a first access point (AP) connected to the first programmable attenuator, for communicating with the mobile communication device;
a second AP connected to the second programmable attenuator, for communicating with the mobile communication device; and
a roaming function test apparatus connected to the first programmable attenuator, the second programmable attenuator, the first AP, and the second AP, for controlling attenuation of the first programmable attenuator to decrease and attenuation of the second programmable attenuator to increase and determining whether the roaming function of the mobile communication device is normal.

2. The roaming function test system of claim 1, wherein the first AP comprises a first body and a first antenna, and the first programmable attenuator comprises a first input connected to the first body and a first output connected to the first antenna.

3. The roaming function test system of claim 2, wherein the second AP comprises a second body and a second antenna, and the second programmable attenuator comprises a second input connected to the second body and a second output connected to the second antenna.

4. The roaming function test system of claim 1, wherein the roaming function test apparatus comprises a general purpose interface bus (GPIB) control card and a network card, and the first programmable attenuator and the second programmable attenuator are respectively connected to the GPIB control card via GPIB cables.

5. The roaming function test system of claim 4, further comprising a hub connected to the roaming function test apparatus via the network card, and connected to the first AP and the second AP via network cables.

6. The roaming function test system of claim 1, wherein roaming function test apparatus comprises:
a testing configuring module, for configuring test data;
a control module connected to the test configuring module, for controlling attenuation of the first programmable attenuator to decrease and attenuation of the second programmable attenuator to increase according to the test data; and
a determining module connected to the test configuring module and the control module, for determining whether the roaming function of the mobile communication device is normal and generating a test report.

7. The roaming function test system of claim 6, wherein the test data comprises configuration data, scenario data, and test item data, and the test item data comprises a predetermined test count and a roaming time.

8. The roaming function test system of claim 7, wherein the test configuring module comprises:
a user interface, for receiving test data input by an operator;
a storage sub-module connected to the user interface, for saving the input test data;
a scanning sub-module connected to the user interface and the storage sub-module, for scanning configuration data of the test data saved in the storage sub-module to determine whether the configuration data is correct; and
a determining sub-module connected to the user interface, the storage sub-module, and the scanning sub-module, for determining whether test data configuration is finished.

9. The roaming function test system of claim 8, wherein the user interface further displays the input test data and the test report.

10. The roaming function test system of claim 8, wherein the determining module further detects whether the roaming function test apparatus can communicate with the first AP or the second AP within a predetermined period, to determine whether the roaming function of the mobile communication device is normal, and retrieves a media access control (MAC) address of the mobile communication device from a corresponding AP communicating with the mobile communication device if the roaming function test apparatus can communicate with the first AP or the second AP within the predetermined period.

11. The roaming function test system of claim 10, wherein the user interface further displays the retrieved MAC address of the mobile communication device.

12. The roaming function test system of claim 7, wherein the roaming function test apparatus further includes a test count determining module connected to the determining module and the test configuring module, for determining whether the test count of the roaming function test system is equal to the predetermined test count of the test item data.

13. A roaming function test method, for testing a roaming function of a mobile communication device, comprising:
configuring test data;
controlling attenuation of a first programmable attenuator to decrease and attenuation of a second programmable attenuator to increase according to the test data;
detecting whether a roaming function test apparatus can communicate with a first AP or a second AP within a predetermined period to determine whether the roaming function of the mobile communication device is normal; and
generating a test report.

14. The roaming function test method of claim 13, wherein the test data comprises configuration data, scenario data, and test item data, and the test item data comprises a predetermined test count and a roaming time.

15. The roaming function test method of claim 14, wherein the step of configuring test data comprises steps of:
receiving and displaying configuration data and scenario data input by an operator, and saving the configuration data and the scenario data in a storage sub-module;
scanning the configuration data in the storage sub-module to determine whether the configuration data is correct;
receiving test item data input by the operator if the configuration data is correct; and
determining whether test data configuration is finished.

16. The roaming function test method of claim 14, further comprising steps of:
determining whether a test count of a roaming function test system is equal to a predetermined test count of the test data.

17. The roaming function test method of claim 13, wherein the step of detecting whether a roaming function test apparatus can communicate with a first AP or a second AP within a predetermined period comprises steps of:
pinging the first AP and the second AP continuously during a roaming time of the test item data; and
determining whether a response is received from the first AP or the second AP within a predetermined period to determine whether the roaming function of the mobile communication device is normal.

18. The roaming function test method of claim 17, wherein the step of detecting whether a roaming function test apparatus can communicate with a first AP or a second AP in a predetermined period comprises steps of:
retrieving a MAC address of the mobile communication device from a corresponding AP communicating with the mobile communication device; and
displaying the retrieved MAC address and the test report.

19. The roaming function test method of claim 17, further comprising steps of:
determining whether the roaming time has elapsed.

20. A method for testing a roaming function of a mobile communication device, comprising steps of:
providing a first access point and a second access point signally communicable with a mobile communication device, respectively;
programmably adjusting signal strength of said first access point and simultaneously, inversely adjusting another signal strength of said second access point so as to respectively simulate relative movement of said first access point and said second access point; and
verifying a roaming function of said mobile communication device between said first access point and said second access point according to signal communication of said first and second access points with said mobile communication device.
